(19) United States
(12) Patent Application Publication
(10) Pub. No.: US 2006/0218203 A1
(43) Pub. Date: Sep. 28, 2006

(54) Replication system and method

(75) Inventors: Junichi Yamato, Tokyo (JP); Masaki Kan, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/387,918

(22) Filed: Mar. 24, 2006

(30) Foreign Application Priority Data
Mar. 25, 2005 (JP) 2005-089454

(51) Int. Cl. G06F 17/30

(52) U.S. Cl. 707/200

(57) ABSTRACT

After a backup of master storage is created, a difference map corresponding to the backup is created. Updates made by a host after creating the backup are recorded in the difference map in the master storage. Backup data is restored to replica storage. A pair of the master storage and the replica storage is created. Data in update locations, generated after creating the backup of the master storage, is transferred to the replica storage based on the difference map to update data in the replica storage and the replica storage is synchronized with the master storage for replication.

### FIELD OF THE INVENTION

The present invention relates to a replication system, and more particularly to a replication system and a replication method with a backup function.

### BACKGROUND OF THE INVENTION

There has been used a computer system that has a primary system (also termed as an active system, or a main) site and a standby system (also termed as an alternate system or a backup) site in order to maintain the operation as an information system even when a disaster occurs. Such a computer system is called a replication system. For example, the primary system site usually provides the system function and, when the primary system site cannot function properly, the standby system site performs operation instead of the primary system site.

The primary system site and the standby system site both have respective storages for storing data to provide the function of the computer system. In the replication system, data in the storage of the primary system site is copied to the storage of the standby system site and retained there to allow the standby system site to operate on behalf of the primary system site. This processing is called “replication”.

Depending upon how the primary system site and the standby system site are updated, the replication system is in one of the following two modes: synchronous mode (synchronous replication) and asynchronous mode (asynchronous replication).

In the synchronous replication mode, when data is written (data writing) in the storage of the primary system site, the same data is written also in the storage of the standby system site. After the data is applied to the storage of both sites, a response to the write instruction is returned to the host of the primary system site.

On the other hand, in the asynchronous replication mode, a response is returned to the host when data is written in the storage of the primary system site and, at another later time, the data is written in the storage of the standby system site.

For use in a system where multiple servers, each having a database therein, are connected via a network, a system is known in which synchronization processing is automatically performed after error recovery and the databases are updated in real time after the synchronization processing (see Patent Document 1). A system is also known in which, when data is transmitted to the standby system to ensure disaster tolerance, the processing of the primary system is not delayed by the transmission of data to the standby system (see Patent Document 2).

[Patent Document 1]

Japanese Patent Kokai Publication No. JP-P2001-290687A

[Patent Document 2]

Japanese Patent Kokai Publication No. JP-P2004-086721A

### SUMMARY OF THE DISCLOSURE

When a replication pair (replication source storage (called “master storage”) and a replication destination storage (called “replica storage”)) is created in a replication system, entire data of the master storage is copied from the master storage to the replica storage via a network. In this case, the replication takes long depending upon the communication speed.

Accordingly, it is an object of the present invention to provide a system suitable for reducing the time required for replication.

The above and other objects are attained by the present invention which has the following configuration.

A replication method in accordance with one aspect of the present invention, comprises:

a step, by a replication source system, for creating a backup of storage of the replication source system and for recording updates, made to the storage after creating the backup, as difference information;

a step, by a replication destination system, for restoring storage of the replication destination system from a backup medium sent from the replication source system; and

a step for transferring update information, generated after creating the backup, from the replication source system to the replication destination system.

Preferably, in the method according to the present invention, a relation of a replication pair is created between the replication source and the replication destination and, if a replication pair creation mode is a use-backup mode, the replication destination and the replication source are synchronized based on the difference information recorded after creating the backup.

Preferably, in the method according to the present invention, for the replication source and the replication destination for which a pair is created, means for controlling a setting of a replication pair determines a selection of either restoration of the backup and transfer of the difference information or transfer of entire data of the replication source via a communication line. The determination is based on an estimation result of a time required for establishing synchronization by the restoration of the backup and the transfer of the difference information and an estimation result of a time required for establishing synchronization by transferring entire data of the replication source via the communication line between the replication source and the replication destination.

Preferably, in the method according to the present invention, with consideration for an increase speed of update data amount in the replication source storage when the replication source and the replication destination are synchronized, said means for controlling a setting of a replication pair estimates the time required for establishing synchronization by the restoration of the backup and the transfer of the difference information, based on an amount of data transferred from the replication source to the replication destination via the communication line, wherein said amount of data is a sum of

an amount of difference information at a time of the determination,

an amount of difference information generated at the replication source during the restoration, and

an amount of difference information generated at the replication source during the transfer of the difference from the replication source to the replication destination.

Preferably, the method according to the present invention, further comprises a step for transferring updates, generated at the replication source system after creating the backup but before executing the restoration using the backup, to update the storage of the replication destination system; and a step for not writing backup data in a location where updating is completed when the restoration is executed at the replication destination system using the backup.

Preferably, in the method according to the present invention, if a replication pair creation mode indicates an initialization mode, means for controlling a setting of a replication pair initializes the storage of the replication source and the storage of the replication destination before starting replication.

Preferably, in the method according to the present invention, if a replication pair creation mode indicates a no-initialization mode, means for controlling a setting of a replication pair checks if the storage of the replication source matches the storage of the replication destination and, if a match occurs, starts replication.

Preferably, in the method according to the present invention, when the check is made for a match between the storage contents of the replication source and the storage contents of the replication destination, the means for controlling a setting of a replication pair takes snapshots of the storage of the replication source and the storage of the replication destination for comparison to check for a match.

Preferably, in the method according to the present invention, when the check is made for a match between the storage contents of the replication source and the storage contents of the replication destination, the means for controlling a setting of a replication pair calculates hash values of data in the storage of the replication source and the storage of the replication destination for comparison to check for a match.

In a system in accordance with another aspect of the present invention, a replication source system comprises a backup device to which a backup of storage of the replication source is stored; a difference map in which updates, generated after creating the backup of the storage of the replication source, are recorded as difference information; and means for transferring update information, generated after creating the backup, to a replication destination system based on the difference map and the replication destination system comprises a backup device for reading backup data from a backup medium in which the backup data is stored from the backup device of the replication source system; means for restoring the backup data of the backup medium into the storage of the replication destination; and means for receiving the update information, transferred from the replication source system for updating the storage of the replication destination based on the difference map.

Preferably, the system according to the present invention, further comprises pairing processing means for pairing the storage of the replication source and the storage of the replication destination.

Preferably, in the system according to the present invention, said pairing processing means determines a selection of either restoration of the backup and transfer of the difference information or transfer of entire data of the replication source via the communication line based on the estimation result of a time required for establishing synchronization by the restoration of the backup data and the transfer of the difference information and a time required for establishing synchronization by transferring entire data of the replication source via the communication line between the replication source and the replication destination.

Preferably, in the system according to the present invention, with consideration for an increase speed of update data amount in the replication source storage when the replication source and the replication destination are synchronized, said means for controlling a setting of a replication pair estimates the time required for establishing synchronization by the restoration of the backup and the transfer of the difference information, based on an amount of data transferred from the replication source to the replication destination via the communication line, wherein said amount of data is a sum of

an amount of difference information at a time of the determination,

an amount of difference information generated at the replication source during the restoration, and

an amount of difference information generated at the replication source during the transfer of the difference from the replication source to the replication destination.

Preferably, the system according to the present invention, further comprises means for transferring update information, generated in the replication source storage after creating the backup, to the replication destination system. The replication source system further comprises update completion flags, each indicating whether a corresponding update location in the storage of the replication destination has been completed or not; means for receiving update information transferred from the replication source system, for updating the storage of the replication destination based on the update information, and for turning on an update completion flag corresponding to an update location; and means for not writing backup data in a location where the update completion flag is on when the restoration is executed using the backup.

Preferably, in the system according to the present invention, if a replication pair creation mode is an initialization mode, the pairing processing means initializes the storage of the replication source and the storage of the replication destination before starting replication.

Preferably, in the system according to the present invention, if a replication pair creation mode indicates a no-initialization mode, the pairing processing means checks if the storage of the replication source matches the storage of the replication destination and, if a match occurs, starts replication.

Preferably, in the system according to the present invention, when the check is made for a match between the storage contents of the replication source and the storage contents of the replication destination, the pairing processing means takes snapshots of the storage of the replication source and the storage of the replication destination for comparison to check for a match.

Preferably, in the system according to the present invention, when the check is made for a match between the storage contents of the replication source and the storage contents of the replication destination, the pairing processing means calculates hash values of data in the storage of the replication source and the storage of the replication destination for comparison to check for a match.

A pairing processing apparatus in accordance with another aspect of the present invention, which is connected to a replication source and to a replication destination connected to the replication source via a communication line, performs control of replication pairing according to a replication pair creation mode pre-set for the replication source and the replication destination. The pairing processing apparatus comprises estimation means for estimating, in case of the replication pair creation mode being a use-backup mode, a first time and a second time and, according to estimation results of the first time and the second time, for determining a selection of either restoration of a backup and transfer of difference information or transfer of entire data of the replication source via the communication line. The first time is a time required for establishing synchronization by the restoration of a storage at the replication destination using backup data backed up from storage of the replication source and the transfer of the difference information, generated after creating the backup at the replication source, from the replication source to the replication destination via the communication line. The second time is a time required for establishing synchronization by the transfer of entire data of the storage of the replication source via the communication line between the replication source and the replication destination.

Preferably, in the pairing processing apparatus according to the present invention, with consideration for an increase speed of update data amount in the replication source storage when the replication source and the replication destination are synchronized, the estimation means estimates the first time required for establishing synchronization by the restoration of the backup and the transfer of the difference information, with a sum of difference data amounts as an amount of data transferred from the replication source to the replication destination via the communication line. The sum of difference data amounts is a sum of an amount of difference information at a time of the determination, an amount of difference information generated at the replication source during the restoration, and an amount of difference information generated at the replication source during the transfer of the difference from the replication source to the replication destination.

Preferably, in the pairing processing apparatus according to the present invention, if the replication pair creation mode is an initialization mode, the pairing processing apparatus initializes the storage of the replication source and the storage of the replication destination before starting replication.

Preferably, in the pairing processing apparatus according to the present invention, if the replication pair creation mode is a no-initialization mode, the pairing processing apparatus checks if the storage of the replication source matches the storage of the replication destination and, if a match occurs, starts replication. When the check is made for a match between the storage contents of the replication source and the storage contents of the replication destination, the pairing processing apparatus takes snapshots of the storage of the replication source and the storage of the replication destination for comparison to check for a match. Alternatively, when the check is made for a match between the storage contents of the replication source and the storage contents of the replication destination, the pairing processing apparatus calculates hash values of data in the storage of the replication source and the storage of the replication destination for comparison to check for a match.

The meritorious effects of the present invention are summarized as follows.

The system and the method according to the present invention reduce the amount of copy after a replication pair is created. The reason is that the backup medium is transported to the replication destination, data is backed up from the backup device, and only the difference data is copied.

The system and the method according to the present invention reduce the time from the moment a replication pair is created to the time synchronization is established.

The system and the method according to the present invention reflect updates, which are generated after creating a backup on the master storage side but before restoring the backup onto the replica storage or which are generated during the restoration, directly onto the replica storage side, thus reducing the time required for restoring the replica storage from the backup data.

The system and the method according to the present invention reduce the load of storage for initial synchronization after a replication pair is created.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIGS. 1A, 1B, 1C, 1D, 1E and 1F are diagrams showing the principle of operation of the present invention.

FIG. 2 is a diagram showing the configuration of a first embodiment of the present invention.

FIG. 3 is a flowchart showing the processing of the first embodiment of the present invention.

FIG. 4 is a flowchart showing the processing procedure (full backup) of backup means 15 in the first embodiment of the present invention.

FIG. 5 is a flowchart showing the processing procedure (difference backup) of backup means 15 in the first embodiment of the present invention.

FIG. 6 is a flowchart showing the processing procedure (before replication is started, asynchronous replication) of access means 13 in the first embodiment of the present invention.

FIG. 7 is a flowchart showing the processing procedure (after replication is started, synchronous replication) of access means 13 in the first embodiment of the present invention.

FIG. 8 is a flowchart showing the processing procedure of pairing processing means 6 in the first embodiment of the present invention.

FIG. 9 is a flowchart showing the processing procedure for the initial copy time estimation in FIG. 8.

FIG. 10 is a flowchart showing the processing procedure of replication replica means 21 in the first embodiment of the present invention.

FIG. 11 is a flowchart showing the processing procedure (synchronous replication) of the replication master means 11 in the first embodiment of the present invention.

FIG. 12 is a flowchart showing the processing procedure (difference transfer, initial copy asynchronous replication) of the replication master means 11 in the first embodiment of the present invention.

FIG. 13 is a flowchart showing the processing procedure of initial copy restore means 23 in the first embodiment of the present invention.

FIG. 14 is a diagram showing the configuration of a second embodiment of the present invention.

FIG. 15 is a flowchart showing the processing procedure of pairing processing means 6 in the second embodiment of the present invention.

FIG. 16 is a flowchart showing the processing procedure (difference transfer, initial copy asynchronous replication) of replication master means 11 in the second embodiment of the present invention.

FIG. 17 is a flowchart showing the processing procedure of replication replica means 21 in the second embodiment of the present invention.

FIG. 18 is a flowchart showing the processing procedure of initial copy restore means 23 in the second embodiment of the present invention.

### PREFERRED EMBODIMENTS OF THE INVENTION

The present invention will be described more in detail with reference to the drawings. According to the present invention, a backup of the master storage that is the replication source is created and the updates in the master storage executed after the creation of said backup are recorded as difference information. The backup data is restored in the replica storage with the information added to indicate that the difference between the replica storage and the master storage is the update information accumulated after the creation of said backup. A pair relation is created for the master storage and the replica storage and then after the pair relation is established, both storages are re-synchronized based on the update information accumulated after the creation of said backup.

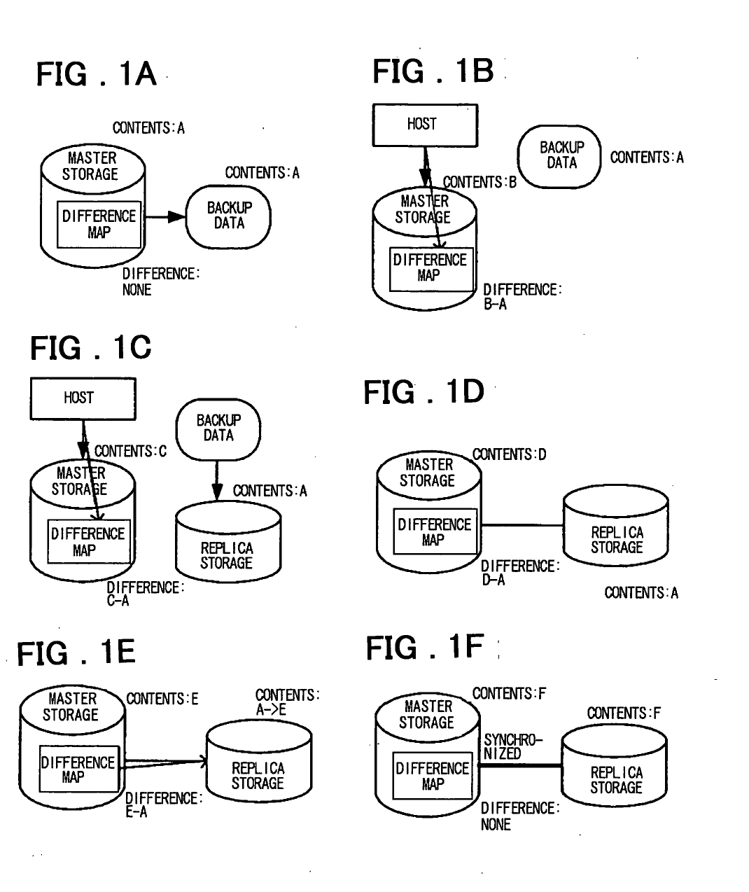

FIG. 1 is a diagram showing the principle of operation of the present invention. The operation of the present invention will be described with reference to FIGS. 1A to 1F, which illustrates the following processes (a) to (f), respectively.

(a) In the present invention, when a backup of the master storage is created, a difference map corresponding to the backup is created as shown in FIG. 1A. The master storage contents are represented by A, and the backup data contents is represented also by A.

(b) The master storage accepts an update from the host and its contents is changed to B, as shown in FIG. 1B. In the master storage, the location of the update from the host is recorded in the difference map. The difference between the master storage contents B and the backup data A is B−A.

(c) The master storage accepts another update from the host and its contents is changed to C, as shown in FIG. 1C. Because the replica storage is created by restoring data from the backup data (content A), its content is A. The difference between the master storage contents C and the backup data A is C−A.

(d) The master storage accepts a still another update from the host and its contents is changed to D, as shown in FIG. 1D. A replication pair is created by specifying that the synchronization error between the master storage and the replica storage is the difference map created in FIG. 1A. If he master storage contents at this moment is D, the difference between the master storage contents and the replica storage contents is D−A.

(e) The master storage accepts a further update from the host and the master storage contents is changed to E, as shown in FIG. 1E. Based on the difference map, the data in the update locations accumulated after creating the backup of the master storage is sent to the replica storage to update the data in the replica storage. The difference between the master storage contents and the replica storage contents is E−A. The replica storage is updated from state A according to the difference map. At the time all updates in the difference map are applied to the replica storage, the master storage and the replica storage, both having contents E, are set in a synchronized state.

(f) The master storage accepts an update from the host and the master storage contents is changed to F, as shown in FIG. 1F. Because the replica storage is synchronized with the master storage with respect to replication, the data is transferred via replication and the replica storage contents is changed to F.

In a modification of the operation described above, a check is made if the backup data restored in the process (c) is the data backed up in the process (a). To do so, a snapshot is created for the master storage when the backup data is created in the process (a) (see FIG. 1A). When the replication pair is created in the process (d) (see FIG. 1D), the snapshot in the master storage is compared with the data in the replica storage. A complete match between them indicates that data in both storages match. In this case, the difference is not copied.

For the comparison, the hash value of the data may also be used. That is, entire data need not be transferred for the comparison.

In the present invention, an update log list may be held instead of the difference map which is fro managing the update locations in logical blocks. Alternatively, journal data including update data may be held.

If a replication pair is created with the same data written in both the master storage and the replica storage, the initial copy operation may be omitted by specifying that both storages store matching data.

A modification of the replication pair creation mode is that, if a replication pair is created immediately after both master storage and the replica storage are initialized, the initial copy operation (restoration of backup data) may be omitted by specifying that both storages store matching data.

Another modification of the replication pair creation mode is that, at the same time a replication pair between the master storage and the replica storage is created, the master storage and the replica storage are initialized. In this case, both the master storage and the replica storage are initialized individually with the same pattern and, after the initialization of both storages, they are made available for use with no initial copy operation.

A still another modification of the replication pair creation mode is that the time required for copying entire data via the network and the time required for the synchronization when data backed up in (c) described above is restored into the replica storage (see FIG. 1C) are compared for selecting the better of the two. That is, the time required for restoring the backup into the replica storage and transferring the difference data is compared with the time required for copying entire data via the network.

The time required for re-synchronization between the master storage and the replica storage may be determined by estimating the update amount of the master storage while synchronization is being executed.

It is also possible to use the average update amount per unit time from the backup time to the current time (determination time). In this case, based on the average update amount and the data amount of backup data, the time required for establishing synchronization by the restoration of the backup and the difference data transfer is compared with the time required for copying entire data via the network.

In the present embodiment, it is also possible to estimate an access pattern may be estimated from the access log of the master storage, to estimate the update amount based on the estimated access pattern, and to compare the time required for establishing synchronization by the restoration of the backup and the difference data transfer with the time required for establishing synchronization by copying entire data via the network.

It is also possible to determine the best method based on the network transfer speed between the master storage and the replica storage. For example, dummy data is used to measure the network transfer speed, and the time required for establishing synchronization by the restoration of the backup and the difference data transfer is compared with the time required for establishing synchronization by copying entire data via the network.

It is also possible to determine the best method based on the capability of backup from the replica storage. In this case, based on the speed of reading data from the backup medium and the amount of backup data, the time required for establishing synchronization by the restoration of the backup and the difference data transfer is compared with the time required for establishing synchronization by copying entire data via the network.

As described above, it is possible to implement a step required for the replication environment; for example, a step for measuring the network transfer speed by transferring dummy data or a step for making a restoration test on the replica storage. The following describes the embodiments.

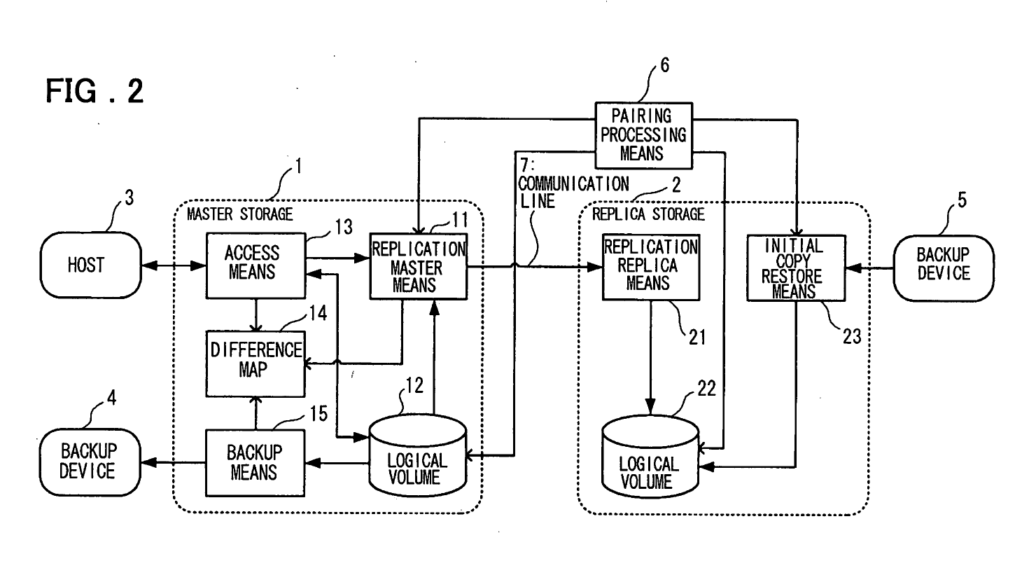

FIG. 2 is a diagram showing the configuration of a first embodiment of the present invention. Referring to FIG. 2, a system according to the first embodiment of the present invention comprises a master storage 1, a replica storage 2, a host 3, a backup device 4 for the master storage 1, a backup device 5 for the replica storage 2, and pairing processing means 6 for controlling the setting of a replication pair (sometimes simply called a “pair”) between the master storage 1 and the replica storage 2. The master storage 1 and the replica storage 2 are connected via a communication line 7. The pairing processing means 6, which comprises a processor for setting a replication pair in the synchronized state and starting the replication, transfers the control signal to and from the master storage 1 and the replica storage 2. Of course, the pairing processing means 6 may be connected to the master storage 1 and the replica storage 2 via a communication line. The pairing processing means 6 may be installed on the master storage 1 side or the replica storage 2 side.

The master storage 1 comprises replication master means 11, a logical volume 12, access means 13 for controlling access from the host 3, a difference map 14, and backup means 15. the replication master means 11 reads from or writes to the logical volume 12 in response to a request from the host 3 and, at the same time, controls the transfer of update information to a replication replica means 21. In the difference map 14, update locations in the logical volume 12 are recorded based on a request from the host 3 after creating a backup. The backup means 15 controls the backup operation (full backup, difference backup) of data of the logical volume 12 onto the backup device 4.

The replica storage 2 comprises replication replica means 21, a logical volume 22, and initial copy restore means 23. The replication replica means 21 receives update information from the replication master means 11 for updating the logical volume 22. The initial copy restore means 23 controls the restoration of data from the backup medium of the backup device 5 to the logical volume 22. Although one master storage 1 and one replica storage 2 are connected via the communication line 7 in FIG. 1, one pairing processing means 6 may also be provided for multiple master storages and multiple replica storages.

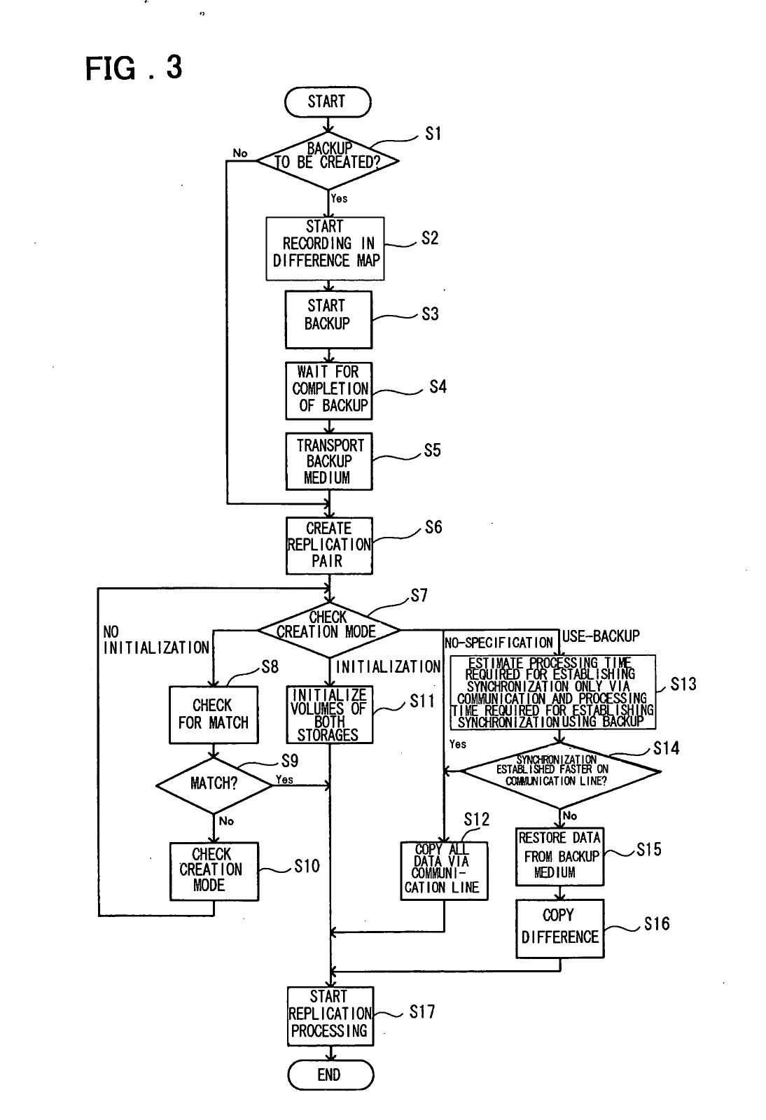

FIG. 3 is a flowchart showing the operation of the first embodiment of the present invention. With reference to FIG. 3, the following describes the operation of the first embodiment of the present invention shown in FIG. 2.

When a backup of the logical volume 12 is created on the backup device 4 (Yes in step S1), the recording in the difference map 14 is started (step S2). The difference map 14 comprises a storage unit including bit information (flags) arranged corresponding to the logical blocks. An update flag is set corresponding to an update location (block) in which data is written by the host 3 after the backup of the logical volume 12 was created.

After that, the backup means 15 starts backing up the data of the logical volume 12 (step S3).

The system waits for the backup to be completed (step S4). After the completion of the backup, the backup medium is transported from the master storage 1 to the replica storage 2 (step S5).

The pairing processing means 6 creates a replication pair between the master storage 1 and the replica storage 2 (step S6). The replication pair is put in the synchronized state and the replication is started.

If the replication pair creation mode is the no-specification mode, the pairing processing means 6 transfers entire data of the master storage 1 to the replica storage 2 via the communication line 7 (step S12). The replication pair creation mode is stored into the storage, no shown, by the pairing processing means 6 and may also be variably set according to the system environment. Although not limited to the modes described below, the replication pair creation mode is one of the following four in the present embodiment: no-specification, use-backup, initialization, and no-initialization.

If the replication pair creation mode is the initialization mode, that is, initial synchronization is performed for the storages, the pairing processing means 6 initializes the volumes of the master storage 1 and the replica storage 2 (step S11). The pairing processing means 6 issues the initialization command to the logical volume 12 of the master storage 1 and to the logical volume 22 of the replica storage 2.

If the replication pair creation mode is the no-initialization mode, that is, initial synchronization is not performed for the storages, the pairing processing means 6 checks for a match between the master storage 1 and the replica storage 2 (step S8). If they do not match, the pairing processing means 6 checks the creation mode (step S11). This is because the initial copy operation is omitted in this mode assuming that the logical volume 12 of the master storage 1 matches the logical volume 22 of the replica storage 2. If they do not match, the processing is inconsistent and, therefore, the pairing processing means 6 checks the replication pair creation mode and changes the mode to a corresponding creation mode.

If the replication pair creation mode is the use-backup mode in the present embodiment, the pairing processing means 6 estimates the processing time required for establishing synchronization by copying entire data of the master storage 1 via communication and the processing time required for establishing synchronization by using a backup (step S13).

If it is found, as the result of processing time estimation, that synchronization is established faster by copying data via the communication line (Yes in step S14), data is copied via the communication line (step S12).

If it is found, as the result of processing time estimation, that synchronization is established faster by using a backup (No in step S14), data is restored from the backup medium (step S15).

After data is restored in step S15, the difference data is copied from the master storage 1 to the replica storage 2 via the communication line 7 (step S16) to re-synchronize the master storage 1 with the replica storage 2.

Once both storages are synchronized, the replication from the master storage 1 to the replica storage 2 is performed (step S17).

In the check for a match in step S8, the data in the master storage 1 is compared with the data in the replica storage 2 to see if they completely match. The hash values of data can also be used for the comparison. This checking eliminates the need for transferring entire data for the comparison.

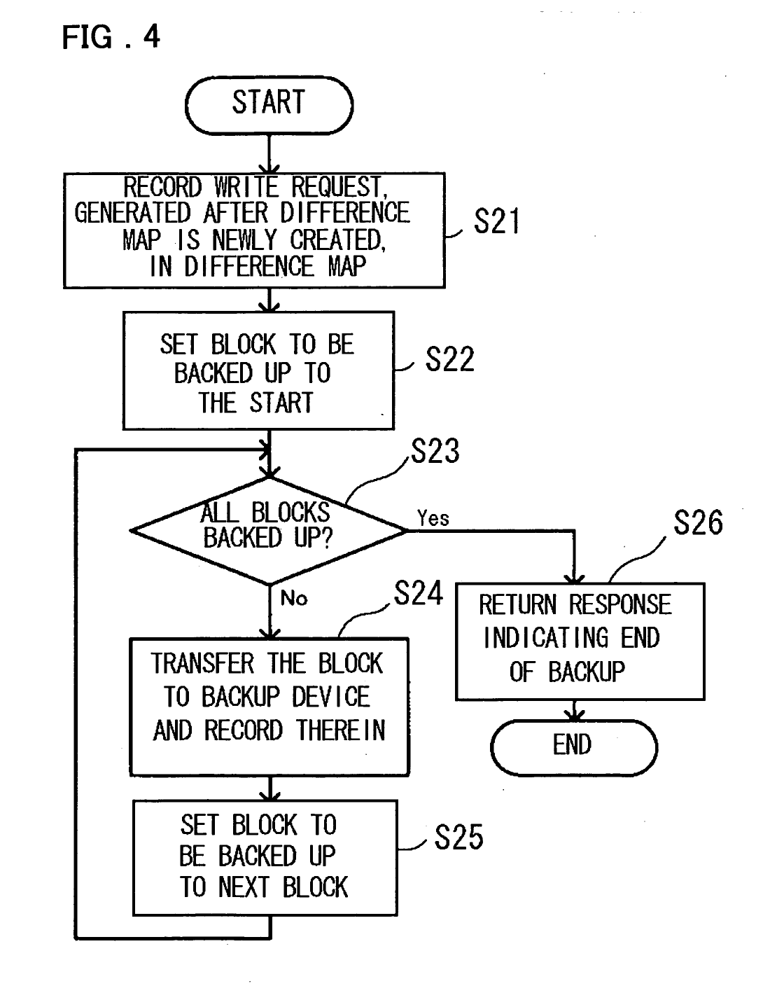

FIG. 4 is a flowchart showing the full backup processing procedure in the present embodiment. The following describes the processing of the backup means 15 that performs full backup processing in the present embodiment.

A write request from the host 3, received after a new difference map 14 is created, is recorded in the difference map 14 (step S21). More specifically, the update flag corresponding to the block specified by a write request from the host 3 is set in the difference map 14.

In the logical volume 12, the block to be backed up is set to the start block of the backup (step S22).

A check is made to determine if all blocks of the logical volume 12 have been backed up (step S23) and, if not, the block to be backed up is transferred to the backup device 4 and written there (step S24).

In the logical volume 12, the block to be backed up is set to the next block (step S25).

If all blocks of the logical volume 12 are backed up, a response indicating the end of backup is returned to the host 3 (step S26).

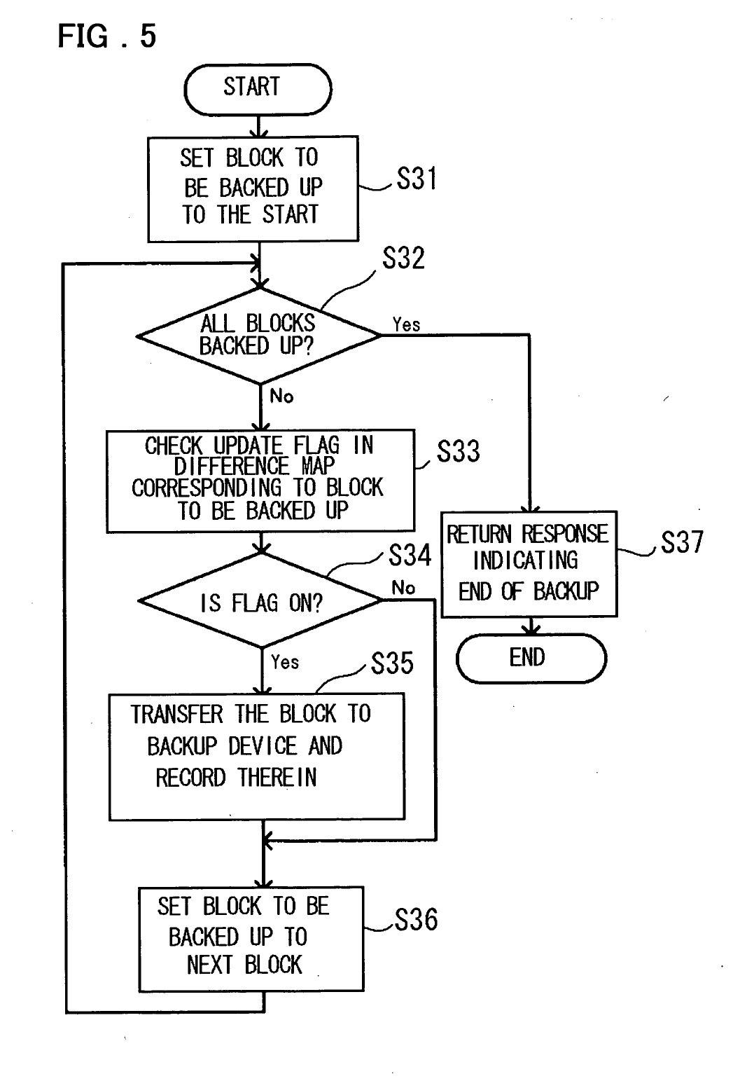

FIG. 5 is a flowchart showing processing procedure for the difference backup in the present embodiment. The following describes the difference backup in the present embodiment. The difference backup is created to selectively back up only the blocks updated after the full backup is created.

In the logical volume 12, the block to be backed up is set to the start (step S31).

A check is made to determine if all blocks of the logical volume 12 have been backed up (step S32) and, if not, the update flag corresponding to the block to be backed up in the difference map 14 is checked (step S33).

If the update flag in the difference map 14 is set (on) (Yes in step S34), the block to be backed up is transferred to the backup device 4 and recorded there (step S35). If the update flag is not set (No in step S34), the backup processing of the block is skipped.

In the logical volume 12, the block to be backed up is set to the next block (step S36).

If all blocks of the logical volume 12 are backed up, a response indicating the end of backup is returned to the host 3 (step S37).

As the storage capacity of the logical volume 12 is increased, it takes long to create a full backup and therefore the full backup is created at a long interval (long period). During that long period, the difference backup is carried out at a short interval (short period) to store update information in the backup device 4 on the master storage 1 side. When data is restored onto the replica storage 2, the backup data backed up in the full backup mode is restored onto the destination logical volume and, after that, the backup data backed up in the difference backup mode is backed up to update the update locations (blocks) of the destination logical block.

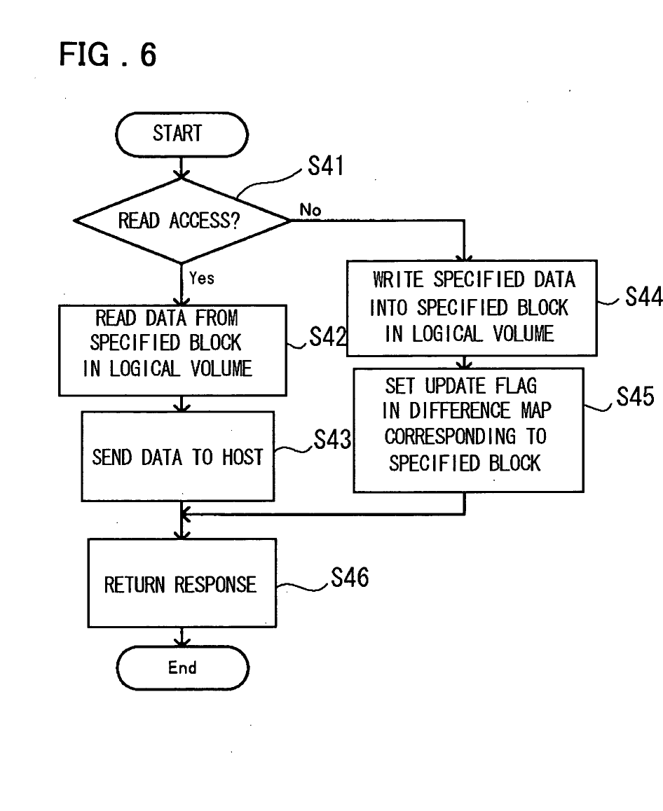

Next, the following describes the processing of the access means 13 in the present embodiment. FIG. 6 is a flowchart showing the processing of the access means 13 before replication is started and when asynchronous replication is performed. With reference to FIG. 6, the following describes the processing before replication is started and asynchronous replication is performed.

The access means 13 checks if an access request from the host 3 is a read access or a write access (step S41). If the access request is a read access, the access means 13 reads the specified block from the logical volume 12 (step S42), sends the data that is read to the host 3 (step S43), and returns a response (step S46).

If the access request is a write access, the access means 13 writes the specified data to the specified block in the logical volume 12 (step S44).

The access means 13 sets the update flag (1 bit allocated to the logical block) in the difference map 14 corresponding to the specified block (step S45).

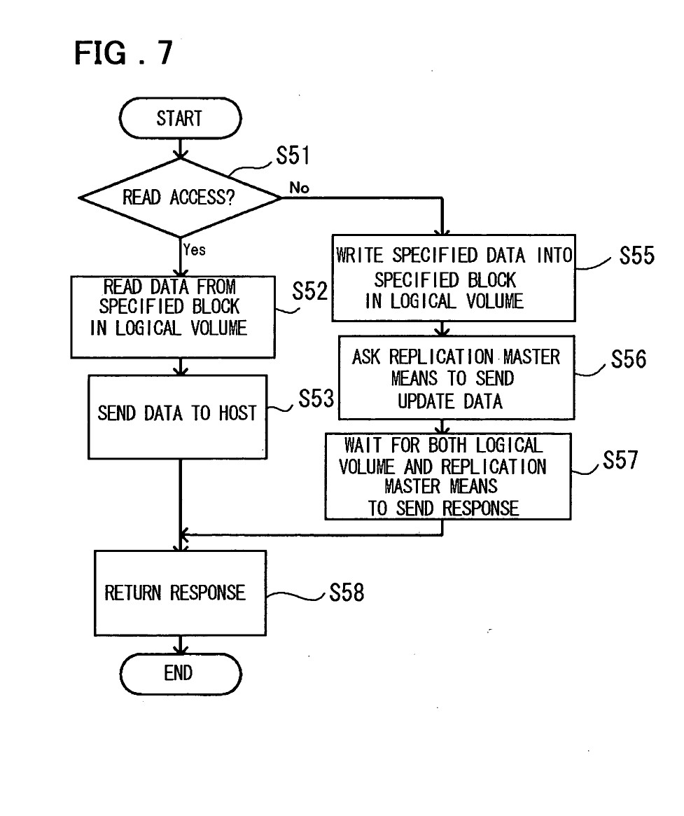

FIG. 7 is a flowchart showing the processing of the access means 13 after replication is started. With reference to FIG. 7, the following describes the processing of the access means 13 after replication is started.

The access means 13 checks if the access request from the host 3 is a read access or a write access (step S51). If the access request is a read access, the access means 13 reads the specified block from the logical volume 12 (step S52), sends the data that is read to the host 3 (step S53), and returns a response (step S58).

If the access request is a write access, the access means 13 writes specified data in the specified block in the logical volume 12 (step S55).

The access means 13 asks the replication master means 11 to transfer the update information to the replication replica means 21 (step S56).

The replication master means 11 issues a request for writing data into the logical volume 12 based on the write access. The access means 13 waits for both the logical volume 12 and the replication master means 11 to send a response (step S57). When the writing of data into the logical volume 12 is completed, the logical volume 12 returns the response to the access means 13. In response to a response from the replication replica means 21 to which the update information was transferred, the replication master means 11 returns the response to the access means 13. Alternatively, the replication master means 11 may also return a pseudo-response to the access means 13 before receiving the response from the replication replica means 21.

The access means 13 returns the response to the host 3 (step S58).

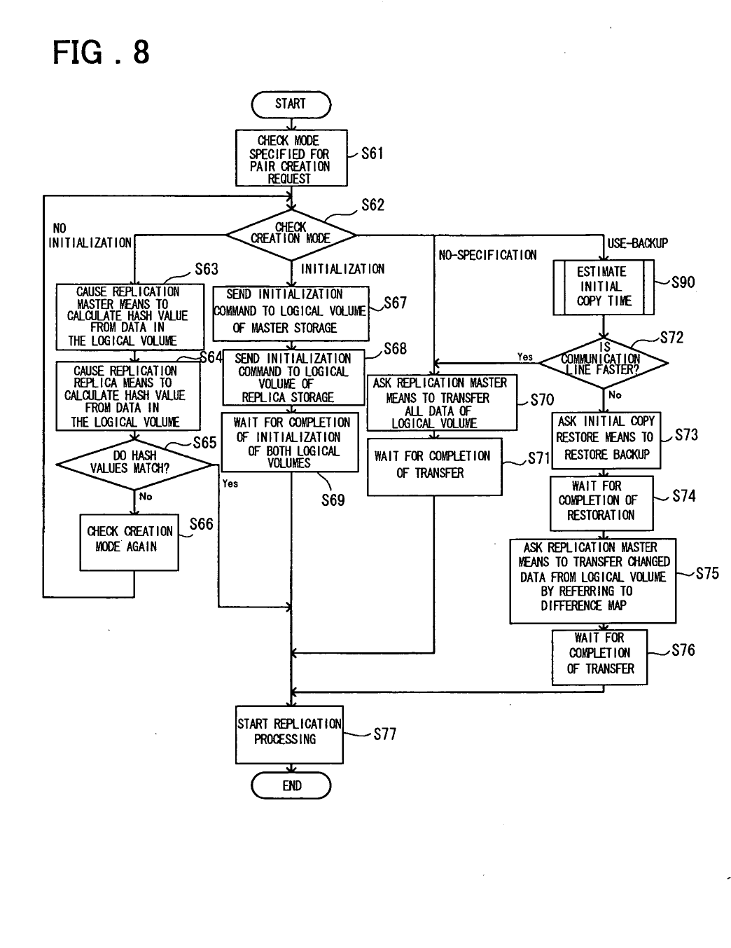

FIG. 8 is a flowchart showing the processing of the pairing processing means 6 in the present embodiment. With reference to FIG. 8, the following describes the processing of the pairing processing means 6 in the present embodiment.

The pairing processing means 6 checks the pair creation mode specified for the pair creation request to create the relation of a replication pair (step S61).

If the pair creation mode is the no-initialization mode (mode in which both storages are assumed to be identical), the pairing processing means 6 causes the replication master means 11 to calculate the hash value from the data in the logical volume 12 (step S63).

The pairing processing means 6 causes the replication replica means 21 to calculate the hash value from the data in the logical volume 22 (step S64).

The pairing processing means 6 checks if the hash values match (step S65) and, if not (No in step S65), checks the creation mode (step S66).

If the hash values match (Yes in step S65), the pairing processing means 6 starts the replication processing (step S77).

On the other hand, if the pair creation mode is the initialization mode as a result of the checking in step S62, the pairing processing means 6 sends the initialization command to the logical volume 12 of the master storage 1 (step S67).

The pairing processing means 6 also sends the initialization command to the logical volume 22 of the replica storage 2 (step S68).

The pairing processing means 6 waits for the completion of the initialization of both logical volumes 12 and 22 (step S69) and, after the completion of initialization, starts the replication processing (step S77).

If the pair creation mode is the no-specification mode as a result of checking in step S62, the pairing processing means 6 asks the replication master means 11 to transfer entire data of the logical volume 12 to the replication replica means 21 (step S70).

The pairing processing means 6 waits for the completion of transfer of data from the master storage 1 to the replica storage 2 (step S71) and, after the completion of transfer (after the establishment of synchronization between the logical volume 12 of the master storage 1 and the logical volume 22 of the replica storage 2), starts replication processing (step S77).

If the pair creation mode is the use-backup mode as a result of checking in step S62, the pairing processing means 6 estimates the initial copy time (step S90).

In step S72, the pairing processing means 6 compares the time (estimated time) required for establishing synchronization via the restoration of the backup and the transfer of the difference and the time (estimated time) required for copying data via the communication line. If it is found that copying data via the communication line requires less time, control is passed to step S70.

On the other hand, if it is found in step S72 that using the backup requires less time, the pairing processing means 6 asks the initial copy restore means 23 to restore the backup (step S73).

The initial copy restore means 23 restores the backup data from the backup medium (medium storing backup data backed up onto the backup device 4) mounted on the backup device 5 onto the logical volume 22.

The pairing processing means 6 waits for the completion of the restoration (step S74) and, after the restoration is completed, asks the replication master means 11 to transfer the difference data, changed in the logical volume 12 after the backup, by referring to the difference map 14 (step S75).

The pairing processing means 6 waits for the completion of the transfer of the difference data (step S76) and, after the completion of the transfer, starts replication processing (step S77).

In a modification of the present embodiment, it is also possible to skip the processing of step S90 and start the restoration of the backup in step S73 without estimating the initial copy time.

In a modification of the present embodiment when no-initialization is selected as the creation mode, it is also possible not to check if the hash values match that is performed in step S63 to S65.

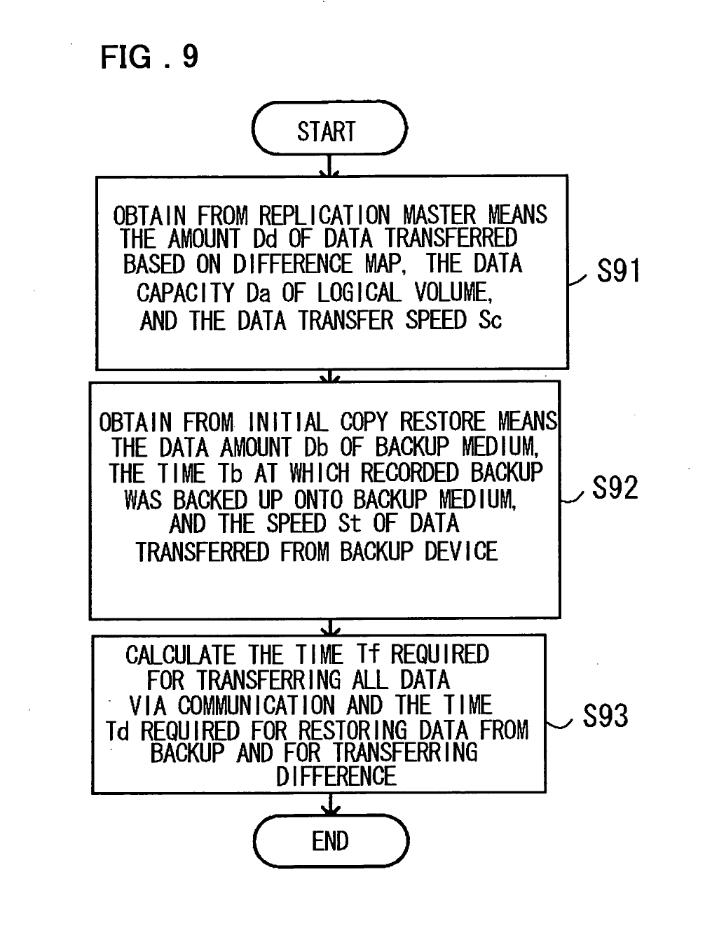

FIG. 9 is a flowchart showing how the pairing processing means 6 estimates the initial copy time. This is a flowchart showing the detailed procedure in step S90 in FIG. 8.

From the replication master means 11, the pairing processing means 6 obtains the amount D_{d} of data to be transferred based on the difference map 14, the data capacity Dₐ of the logical volume 12, and the data transfer speed S_{c} via the communication line (step S91).

From the initial copy restore means 23, the pairing processing means 6 obtains the data amount D_{b} of the backup medium, the time T_{b} at which recorded backup was backed up onto the backup medium, and the speed Sₜ of data transferred from the backup device 5 to the logical volume 22 (step S92).

The pairing processing means 6 calculates the time T_{f} required for transferring entire data via the communication line 7 and the time T_{d} required for restoring data from the backup and for transferring the difference (step S93). For example, the data amount D_{b} and the time information T_{b} recorded in the backup medium are used. The following describes an example of calculation of T_{f} and T_{d}.

In the description below, the following symbols are used.

T_{f}: Time required for transferring entire data from the master storage 1 to the replica storage 2 via communication

T_{d}: Time required for restoring backup data onto the replica storage 2 and for transferring the difference data from the master storage side to the replica storage 2 via the communication line

D_{d}: Amount of data transferred via the communication line based on the difference map when determination is made

Dₐ: Amount of entire data in the logical volume 12

S_{c}: Speed of data transfer (data transfer rate) via communication

D_{b}: Data amount of backup medium

T_{b}: Time at which data was backed up onto the backup medium mounted on the backup device 4

Sₜ: Speed of data transfer (data transfer rate) from the backup device 5

T_{f} and T_{d} are represented by following expressions (1) and (2), respectively.
T_{f}=Dₐ/S_{c} (1)
T_{d}=D_{b}/Sₜ+D_{d}/S_{c} (2)

If T_{f}>T_{d}, the pairing processing means 6 restores data from the backup device 5 to the logical volume 22 of the replica storage 2.

If T_{f}<T_{d}, the pairing processing means 6 copies entire data from the logical volume 12 of the master storage 1 to the logical volume 22 of the replica storage 2 via the communication line 7.

If T_{f}=T_{d}, the pairing processing means 6 may either restore data from the backup device 5 and copy the difference data or transfer entire data via the communication line 7.

Next, as a modification of the present embodiment, the following describes how the pairing processing means 6 estimates the update amount on the master storage 1 side that is synchronized and selects between the method of restoring data from the backup device 5 and copying the difference data and the method of transferring entire data via the communication line 7.

Let t be the time required for transferring the difference data (transfer speed of communication line 7=S_{c}) and let V be the increase speed of the update data amount in the logical volume 12 of the master storage 1 that is synchronized.

Then, the amount of data transferred from the master storage 1 is the sum of the difference data amount at the determination time, the difference data amount generated while backup data is applied, and the difference data amount generated during the transfer of the difference data. S_{c}·t is given as follows:
S_{c}·t=D_{d}+V·D_{b}/Sₜ+V·t (3)

Solving the equation (3) for t, we have:
t=(D_{d}·Sₜ+V·D_{b})/{Sₜ·(S_{c}−V)} (4)

The time T_{d} required for restoring data from the backup and for transferring the difference, which is the sum of the transfer time D_{b}/Sₜ of backup data and the transfer time t of difference data via the communication line 7, is given by the following equation (5).

$$\begin{matrix}{T}_{d} = {D}_{b} / {S}_{t} + t \\ = {D}_{b} + ( {D}_{d} \cdot {S}_{t} + V \cdot {D}_{b} ) / \{ {S}_{t} \cdot ( {S}_{c} - V ) \}\end{matrix} \qquad ( 5 )$$

As the value of V, either the data update amount of the master storage estimated from the characteristics of applications or the actual measured result of the update amount may be used.

Let T_{c} be the time of determination. Then, V is given by the following equation (6).
V=D_{d}/(T_{c}−T_{b}) (6)

Therefore, replacing V in the equation (4), which is the expression for t, with V in the equation (6), we have:
t={(T_{c}−T_{b})·Sₜ+D_{b}}·D_{d}/[Sₜ·{S_{c}·(T_{c}−T_{b})−D_{d}}] (7)

Replacing V in the equation (5) with V in the equation (6) shown above gives the equation (8) for Td shown below. Tf is given by the equation (9).
T_{d}=(T_{c}−T_{b})(D_{b}·S_{c}+D_{d}·Sₜ)/[Sₜ·{S_{c}·(T_{c}−T_{b})−D_{d}}] (8)
T_{f}=Dₐ/S_{c} (9)

If T_{f}>T_{d}, the pairing processing means 6 restores data from the backup device 5 and copies the difference data.

If T_{f}<T_{d}, the pairing processing means 6 copies entire data via the communication line 7.

If Tf=Td, the pairing processing means 6 may either restore data from the backup device 5 and copy the difference data or copy entire data via the communication line 7.

Alternatively, the estimation of the initial copy time may be determined from the data transfer speed.

If Sₜ>S_{c} (that is, the speed of data transfer from the backup device 5 is higher than the speed of data transfer via the communication line), the pairing processing means 6 restores data from the backup device 5 and copies the difference data.

If Sₜ<S_{c} (that is, the speed of data transfer from the backup device 5 is lower than the speed of data transfer via the communication line), the pairing processing means 6 copies entire data via the communication line 7.

If Sₜ=S_{c}, the pairing processing means 6 may either restore data from the backup device 5 and copy the difference data or copy entire data via the communication line 7.

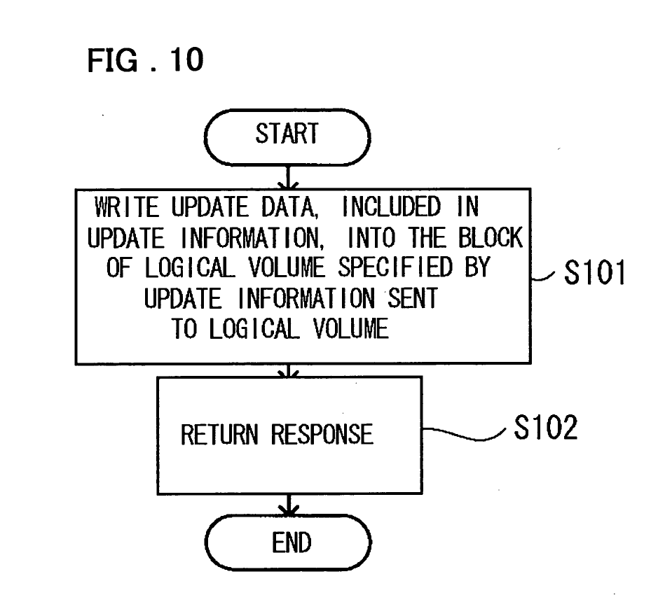

FIG. 10 is a flowchart showing the processing procedure of the replication replica means 21 in the present embodiment. The following describes the processing of the replication replica means 21 in the present embodiment with reference to FIG. 10. Upon receiving update information from the replication master means 11, the replication replica means 21 writes the update data, included in the update information, into the block of the logical volume specified by the update information sent to the logical volume 22 (step S101).

The replication replica means 21 returns a response to the replication master means 11 (step S102).

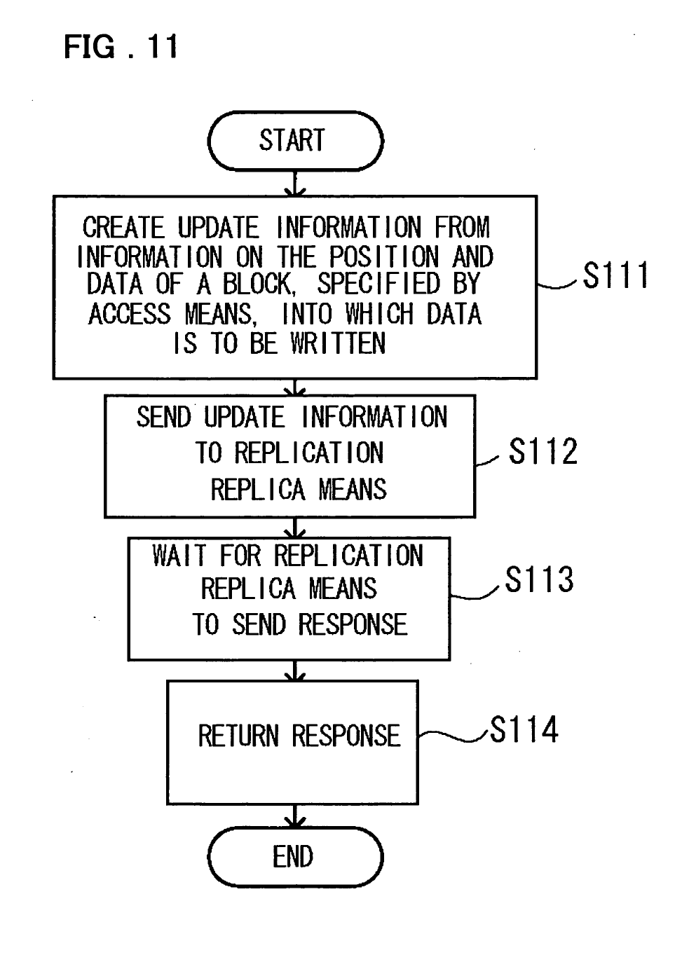

FIG. 11 is a flowchart showing the processing procedure of the replication master means 11 in the present embodiment. The following describes the processing of the replication master means 11 in the present embodiment with reference to FIG. 11. The following also describes synchronized replication.

The replication master means 11 creates update information from the information on the position and data of a block, specified by the access means 13, into which data is to be written (step S111).

The replication master means 11 sends the update information to the replication replica means 21 (step S112).

The replication master means 11 waits for the replication replica means 21, which received the update information, to send a response indicating the completion of the update of the logical volume 22 (step S113).

In response to the response from the replication replica means 21 indicating the completion of update, the replication master means 11 returns a response to the access means 13 (step S114).

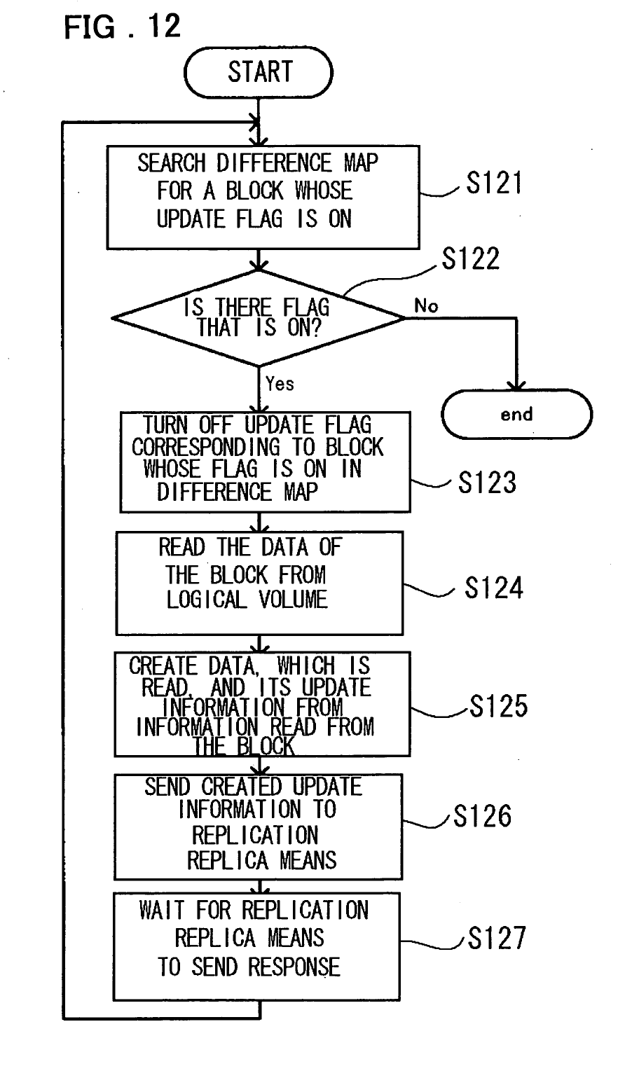

FIG. 12 is a flowchart showing the processing procedure of the replication master means 11 in the present embodiment. The following describes the transfer of difference information using the difference map 14 that is performed by the replication master means 11.

The replication master means 11 searches the difference map 14 for a block whose update flag is on (step S121).

If there is such a block, the replication master means 11 turns off the update flag of the block whose flag is on in the difference map 14 (step S123).

The replication master means 11 reads the data of the block from the logical volume (step S124).

The replication master means 11 creates data, which is read, and its update information from the information read from the block (step S125).

The replication master means 11 sends the created update information to the replication replica means 21 (step S126).

The replication master means 11 waits for the replication replica means 21 to send a response (step S127). In response to the response, control is passed to step S121 and the difference map is checked in step S122 to see if there is a flag that is on. The processing from step S121 to S127 is executed until there is no flag that is on in the difference map 14.

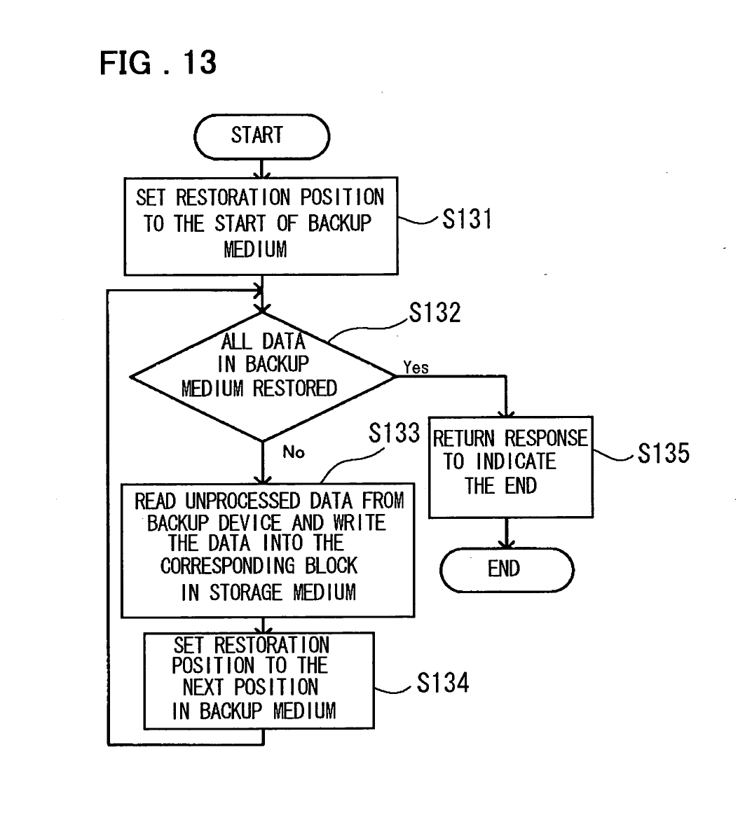

FIG. 13 is a flowchart showing the processing procedure of the initial copy restore means 23 in the present embodiment. The following describes the processing of the initial copy restore means 23.

The initial copy restore means 23 sets the restoration position to the start of the backup medium mounted on the backup device 5 (step S131).

The initial copy restore means 23 checks if entire data in the backup medium, from which data is restored, has been restored (step S132). If there is unprocessed data, the initial copy restore means 23 reads unprocessed data from the backup device and writes the data into the corresponding block in the storage medium (step S133).

The initial copy restore means 23 sets the restoration position to the next position in the backup medium (step S134) and passes control to step S132.

If entire data in the backup medium, from which data is restored, has been restored, the initial copy restore means 23 returns a response to indicate the end of restoration (step 135).

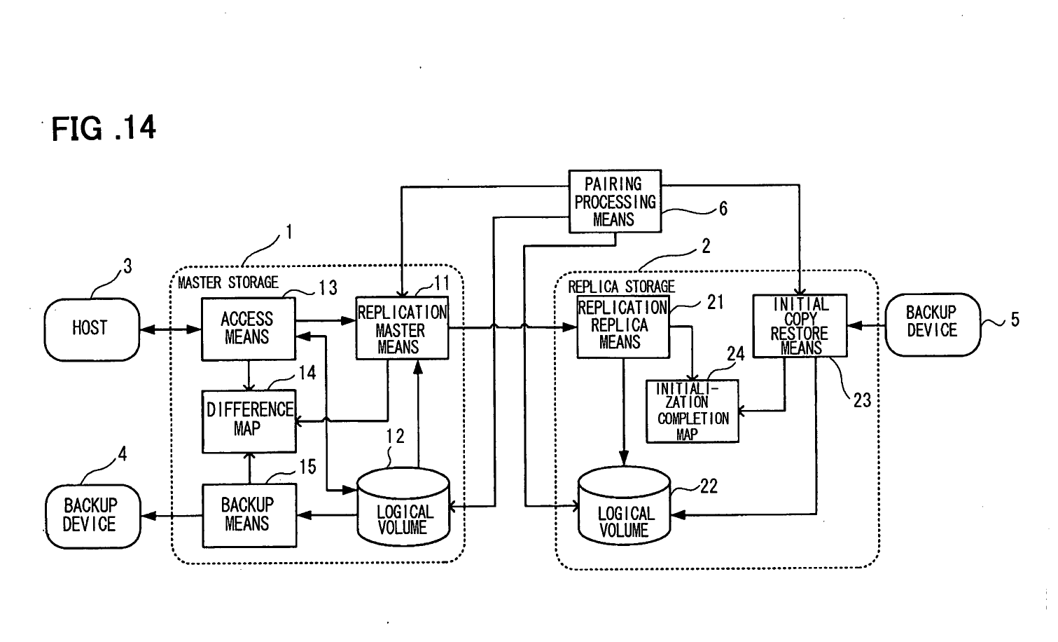

Next, a second embodiment of the present invention will be described. FIG. 14 is a diagram showing the configuration of the second embodiment of the present invention. In the second embodiment of the present invention, an update that was made in master storage 1 after a backup is transferred to replica storage 2 for updating the replica storage 2. When data is restored from a backup device 5, initial copy restore means 23 does not write the backup data of a block that is already updated.

As shown in FIG. 14, the replica storage 2 in the present embodiment comprises replication replica means 21, a logical volume 22, initial copy restore means 23 and, in addition, an initialization completion map 24. The rest of the components are the same as those in the first embodiment shown in FIG. 2. The following describes only the components different from those in the first embodiment and omits the repetitive description of the same components to avoid redundancy.

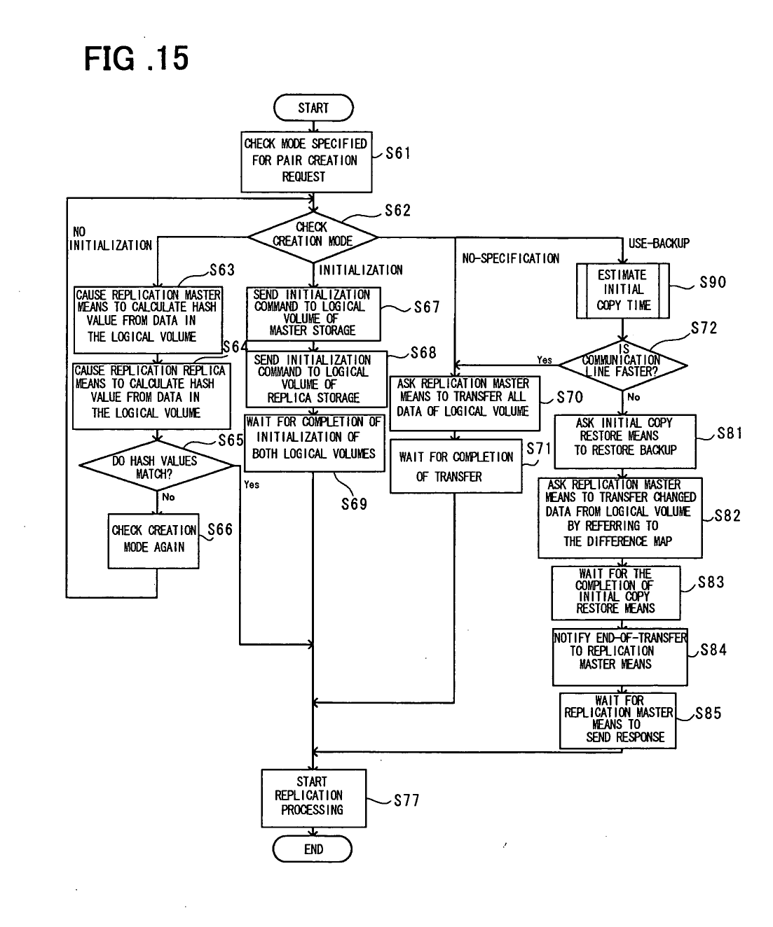

FIG. 15 is a flowchart showing the processing procedure of pairing processing means 6 in the present embodiment. The following describes the processing of the pairing processing means 6 in the present embodiment. The description of the parts that are the same as those in FIG. 8 is omitted.

If the creation mode is the use-backup mode, the pairing processing means 6 estimates the initial copy time (step S90).

If it is found that using the backup requires less time, the pairing processing means 6 asks the initial copy restore means 23 to restore the backup (step S81).

The pairing processing means 6 asks the replication master means 11 to transfer the changed data from the logical volume by referring to the difference map 14 (step S82).

The pairing processing means 6 waits for the completion of the initial copy restore means 23 (step S83).

The pairing processing means 6 notifies an end-of-transfer to the replication master means 11 (step S84).

The pairing processing means 6 waits for the replication master means 11 to send a response (step S85).

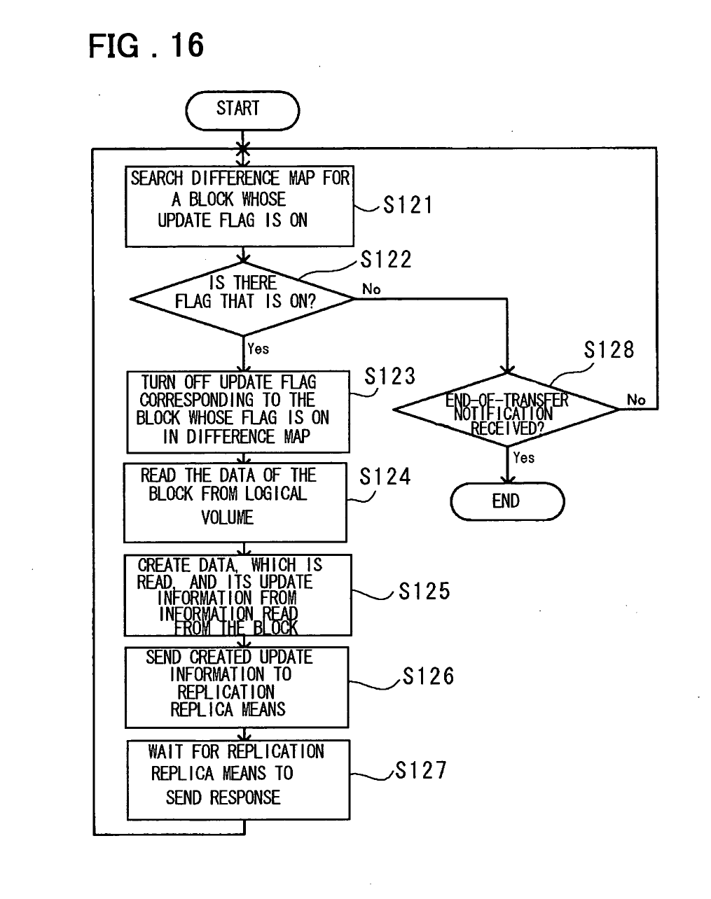

FIG. 16 is a flowchart showing the processing procedure of the replication master means 11 in the present embodiment. With reference to FIG. 16, the following describes how the replication master means 11 transfers data using the difference map 14.

The replication master means 11 searches the difference map 14 for a block whose update flag is on (step S121).

If no update flag is on in the difference map 14 (No in step S122), the replication master means 11 checks if the end-of-transfer notification is received (step S128) and, if not, passes control back to step S121.

If there is an update flag that is on in the difference map 14, the replication master means 11 performs the same processing as in steps S123-S127 in FIG. 12.

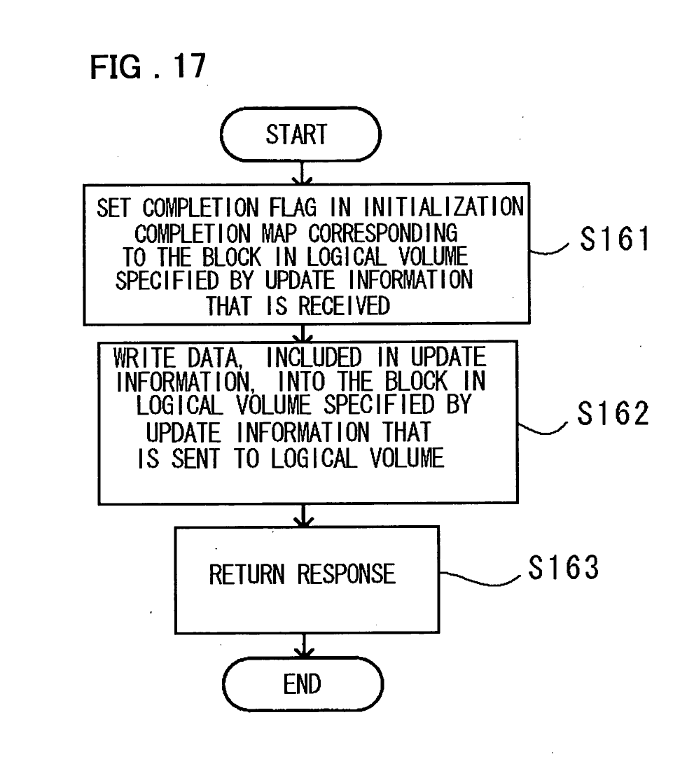

FIG. 17 is a flowchart showing the processing procedure of the replication replica means 21 in the present embodiment. With reference to FIG. 17, the following describes the processing performed by the replication replica means 21 when it receives data from the replication master means 11.

The replication replica means 21 sets a completion flag in the initialization completion map corresponding to a block in the logical volume specified by update information that is received (step S161).

The replication replica means 21 writes data, included in the update information, into the block in the logical volume specified by the update information that is sent to the logical volume (step S162).

The replication replica means 21 returns a response to the replication master means 11 (step S163).

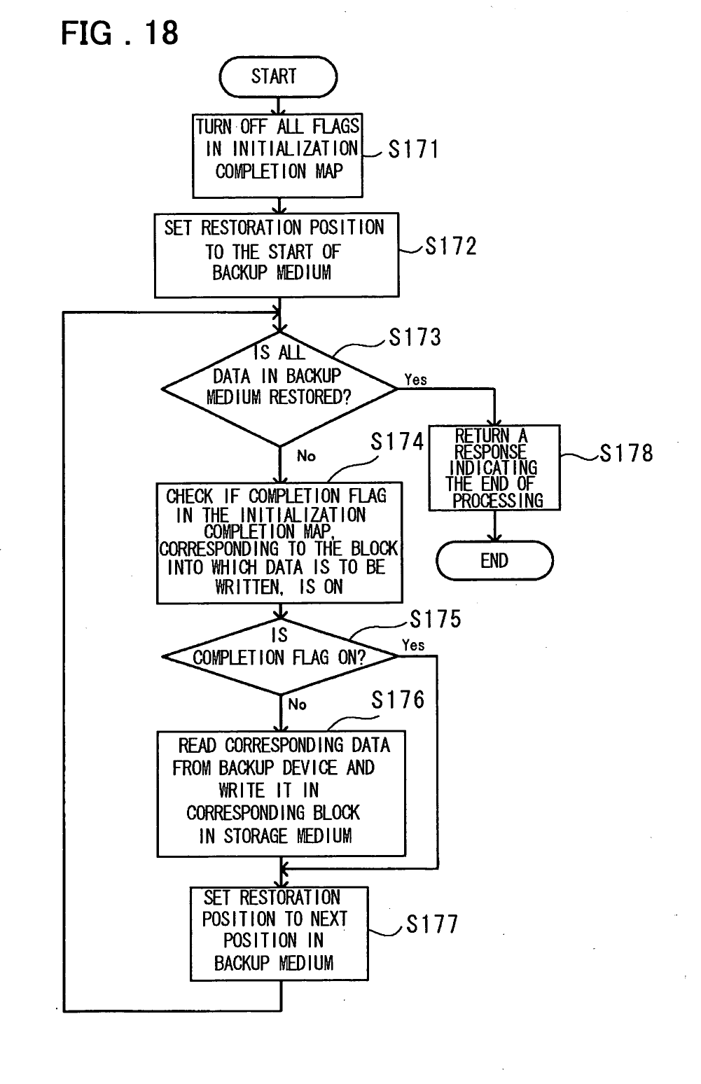

FIG. 18 is a flowchart showing the processing procedure of the initial copy restore means 23 in the present embodiment. With reference to FIG. 18, the following describes the processing of the initial copy restore means 23.

The initial copy restore means 23 turns off all flags in the initialization completion map (step S171).

The initial copy restore means 23 sets the restoration position to the start of the backup medium from which data is to be restored (step S172).

If entire data in the backup medium, from which data is restored, is not yet restored (No in step S173), the initial copy restore means 23 checks if the completion flag in the initialization completion map 24 corresponding to the block, into which data is to be written, is on (step S174).

If the corresponding completion flag in the initialization completion map 24 is on, control is passed to step S177. If the flag is not on, the initial copy restore means 23 reads the corresponding data from the backup medium mounted on the backup device 5 and writes it in the corresponding block in the logical volume 22 (step S176).

The initial copy restore means 23 sets the restoration position to the next position in the backup medium (step S177).

If entire data is restored from the backup medium from which data is to be restored, the initial copy restore means 23 returns a response indicating the end of processing (step S178).

It is of course possible to provide an intermediate device between the master storage 1 and the replica storage 2 to temporarily store update information from the master storage in a buffer and transfer the stored information to the replica storage.

The system in charge of replication may be a server instead of a device on a storage level. In this case, the replication master means and the replication replica means are server computers. Alternatively, it is of course possible that a switch between the server and the storage controls replication. The communication line is any line or a network such as the Internet, a leased line, a LAN, and a WAN (Wide Area Network).

Although the present invention has been described with reference to the preferred embodiments thereof, the present invention is not limited to the configuration of the embodiments but includes various other changes and modifications that may be accomplished by those skilled in the art without departing from the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A replication method comprising:
creating, by a replication source system, a backup of a storage of said replication source system;
recording, by a replication source system, an update made to the storage of said replication source system, after creating said backup, as difference information;
restoring, by a replication destination system, a storage of said replication destination system from a backup medium sent from said replication source system; and
transferring update information as to the update made to the storage of said replication source system after creating said backup, from said replication source system to said replication destination system.

2. The replication method according to claim 1, wherein a relation of a replication pair is formed between the replication source and the replication destination and, in case of a replication pair creation mode being a use-backup mode, the replication destination and the replication source are synchronized, based on the difference information recorded after creating said backup.

3. The replication method according to claim 1, wherein, for the replication source system and the replication destination system which form a relation of a replication pair, means for controlling a setting of a replication pair determines a selection of either restoration of the backup and transfer of the difference information or transfer of entire data of the replication source system via a communication line,
said determination being based on
an estimation result of a time required for establishing synchronization by the restoration of the backup and the transfer of the difference information; and
an estimation result of a time required for establishing synchronization by transferring entire data of the replication source via a communication line between the replication source and the replication destination.

4. The replication method according to claim 3, wherein said means for controlling a setting of a replication pair estimates the time required for establishing synchronization by the restoration of the backup and the transfer of the difference information, based on an amount of data transferred from the replication source to the replication destination via the communication line,
said amount of data being a sum of
an amount of difference information at a time of the determination,
an amount of difference information generated at the replication source system during the restoration, and
an amount of difference information generated at the replication source system during the transfer of the difference from the replication source to the replication destination.

5. The replication method according to claim 1, further comprising:
transferring update information as to an update made to the storage of said replication source system in a period as from the creation of said backup before the restoration using the backup executed in the replication destination system, from said replication source system to said replication destination system, to update the storage of said replication destination system; and
controlling, by said replication destination system, so as not to write backup data in a location where the update corresponding to said update information is completed, when said replication destination system executes the restoration using the backup.

6. The replication method according to claim 1 wherein, if a replication pair creation mode is an initialization mode, means for controlling a setting of a replication pair initializes the storage of the replication source and the storage of the replication destination before starting replication.

7. The replication method according to claim 1, wherein, if a replication pair creation mode is a no-initialization mode, means for controlling a setting of a replication pair checks if the storage contents of the replication source matches the storage contents of the replication destination and, if a match occurs, starts replication.

8. A replication system including a replication source system and a replication destination system connected to said replication source system via a communication line;
said replication source system comprising:
a backup device to which a backup of a storage of the replication source system is stored;
a difference map in which an update made to the storage of the replication source after creating the backup of the storage of the replication source, is recorded as difference information; and
means for transferring update information as to the update made to the storage of the replication source after creating the backup, to said replication destination system based on the difference map;
said replication destination system comprising:
a backup device for reading backup data from a backup medium in which the backup data is stored from said backup device of said replication source system;
means for restoring the backup data of said backup medium into a storage of the replication destination; and
means for receiving the update information, transferred from said replication source system to update the storage of the replication destination system.

9. The replication system according to claim 8, further comprising
pairing processing means for forming a relation of a replication pair between the replication source system and the replication destination system according to a pre-set mode.

10. The replication system according to claim 9, wherein said pairing processing means determines a selection of either restoration of the backup and transfer of the difference information or transfer of entire data of the replication source system via the communication line,
said determination being based on
an estimation result of a time required for establishing synchronization by the restoration of the backup at the replication destination and the transfer of the difference information from the replication source system to the replication destination system via the communication line; and
an estimation result of a time required for establishing synchronization by transferring entire data of the replication source system via the communication line between the replication source system and the replication destination system.

11. The replication system according to claim 10, wherein said pairing processing means estimates the time required for establishing synchronization by the restoration of the backup and the transfer of the difference information, based on an amount of data transferred from the replication source to the replication destination via the communication line,
said an amount of data being a sum of
an amount of difference information at a time of the determination,
an amount of difference information generated at the replication source during the restoration, and
an amount of difference information generated at the replication source during the transfer of the difference from the replication source to the replication destination.

12. The replication system according to claim 8, wherein said replication source system further comprises
means for transferring update information, generated in the replication source storage after creating the backup, to said replication destination system; and wherein
said replication destination system further comprises:
a plurality of update completion flags each indicating completion of an update location in the storage of the replication destination;
means for receiving update information transferred from said replication source system, for updating the storage of the replication destination based on the update information, and for turning on an update completion flag corresponding to an update location; and
means for controlling not to write backup data in a location where said update completion flag is set on when the restoration using the backup is executed.

13. The replication system according to claim 9, wherein, if a replication pair creation mode is an initialization mode, said pairing processing means initializes the storage of the replication source and the storage of the replication destination before starting replication.

14. The replication system according to claim 9, wherein, if a replication pair creation mode is a no-initialization mode, said pairing processing means checks if the storage of the replication source matches the storage of the replication destination and, if a match occurs, starts replication.

15. A pairing processing apparatus, connected to a replication source and to a replication destination which is connected to said replication source via a communication line, said apparatus comprising:
means for controlling replication pairing according to a replication pair creation mode pre-set for the replication source and the replication destination; and
estimation means for estimating a first time and a second time and for determining a selection of either restoration of a backup and transfer of difference information or transfer of entire data of the replication source via the communication line, according to estimation results of the first time and the second time, when the replication pair creation mode is a use-backup mode, said first time being a time required for establishing synchronization by the restoration of a storage at the replication destination using backup data backed up from storage of the replication source and the transfer of the difference information, generated after creating the backup at the replication source, from the replication source to the replication destination via the communication line;
said second time being a time required for establishing synchronization by the transfer of entire data of the storage of the replication source via the communication line between the replication source and the replication destination.

16. The pairing processing apparatus according to claim 15, wherein,
said estimation means estimates the first time required for establishing synchronization by the restoration of the backup and the transfer of the difference information, based on an amount of data transferred from the replication source to the replication destination via the communication line,
said amount of data being a sum of
an amount of difference information at a time of the determination,
an amount of difference information generated at the replication source during the restoration, and
an amount of difference information generated at the replication source during the transfer of the difference from the replication source to the replication destination.

17. The pairing processing apparatus according to claim 15, wherein, if the replication pair creation mode is an initialization mode, said pairing processing apparatus initializes the storage of the replication source and the storage of the replication destination before starting replication.

18. The pairing processing apparatus according to claim 15, wherein, if the replication pair creation mode is a no-initialization mode, said pairing processing apparatus checks if the storage contents of the replication source matches the storage contents of the replication destination and, if a match occurs, starts replication.

19. The pairing processing apparatus according to claim 18, wherein, when the check is made for a match between the storage contents of the replication source and the storage contents of the replication destination, said pairing processing apparatus takes respective snapshots of the storage of the replication source and the storage of the replication destination for comparison to check for a match.

20. The pairing processing apparatus according to claim 18, wherein, when the check is made for a match between the storage contents of the replication source and the storage contents of the replication destination, said pairing processing apparatus calculates respective hash values of data in the storage of the replication source and the storage of the replication destination for comparison to check for a match.
